(19) United States
(12) Patent Application Publication
(10) Pub. No.: US 2012/0202166 A1
(43) Pub. Date: Aug. 9, 2012

(54) VIBRATING DENTAL INSTRUMENTS

(75) Inventors: Beat Kilcher, Bosco Luganese (CH); Angelo Putignano, Ancona (IT); Marco Da Rold, Odogno (CH); Hinko Kovacevic, Bronschhofen (CH)

(73) Assignee: KERRHAWE SA, Bioggio (CH)

(21) Appl. No.: 13/451,795

(22) Filed: Apr. 20, 2012

Related U.S. Application Data
(63) Continuation-in-part of application No. 12/634,986, filed on Dec. 10, 2009.

(51) Int. Cl. A61C 3/00; A61C 5/14; A61C 5/04

(52) U.S. Cl. 433/27

(57) ABSTRACT

A vibrating dental instrument is provided that may be used with different styles of tips for performing different dental procedures. The dental instrument has an elongated body and a tip that is releasably coupled to the elongated body. The dental instrument further has a vibrating apparatus for vibrating the tip and a sensor for sensing a condition of a dental composite material when the tip is used to apply the dental composite material onto a tooth. A controller is operatively coupled to the vibrating apparatus and to the sensor and is configured to automatically vary an output frequency of the vibrating apparatus in response to the condition sensed by the sensor.

### CROSS-REFERENCE TO RELATED APPLICATION

This application is a continuation-in-part of pending U.S. patent application Ser. No. 12/634,986, which was filed on Dec. 10, 2009, published as United States Patent Pub. No. 2011/0143303, and is incorporated herein by reference in its entirety.

### TECHNICAL FIELD

This invention relates generally to dental instruments and, more particularly, to vibrating dental instruments and associated tips for performing dental procedures, including applying a dental composite material onto a tooth.

### BACKGROUND

Instruments are known for applying a dental composite material onto a tooth. A disadvantage of composite materials, however, is their tendency to adhere more or less to the instrument that is used to apply or shape them. As a result, and by way of example, the composite material has a tendency to be drawn off from the edges of the cavity, to be distributed inhomogeneously on the tooth surface, and to form air bubbles during the distribution.

To this end, instruments have been developed that address the challenges observed in the application of composite materials. For example, known instruments may include coatings such as TiN, or Teflon™, for example, on the working tip of the instrument to minimize the likelihood of the composite material adhering to the tip. Other instruments may include a vibrating tip. In instruments of this type, however, the tip may vibrate at a fixed frequency and/or amplitude, in which case the material adheres to the tip when the viscosity of the material reaches a predetermined level, characteristic of the particular material. For example, an instrument may apply a composite material with a predetermined, fixed output frequency of vibration. Initially, the viscosity of the material is reduced to an acceptable level by virtue of engagement of the instrument with the material. After a predetermined length of time of engagement, however, the viscosity of the material may reach a level at which the material adheres to the tip of the instrument, which is undesirable. The user may then be forced to clean or replace the instrument altogether. Similarly, for a predetermined output frequency of vibration, there may be a difference in the viscosity level of the composite material according to the depth of insertion of the tip of the instrument into the material, which may also result in adhesion of portions of the material having a particular level of viscosity.

It is therefore desirable to provide a dental instrument that addresses these and other problems associated with conventional instruments used to apply a dental composite material onto a tooth. It is also desirable to enhance the capabilities of such a dental instrument by making it useful for dental procedures in addition to applying a dental composite material onto a tooth.

### SUMMARY

The present invention overcomes the foregoing and other shortcomings and drawbacks of applicators heretofore known for applying a dental composite material onto a tooth. While the invention will be discussed in connection with certain embodiments, it will be understood that the invention is not limited to these embodiments. On the contrary, the invention includes all alternatives, modifications, and equivalents as may be included within the scope of the invention.

An applicator is provided for applying a dental composite material onto a tooth. The applicator has an elongated body and a tip that is coupled to the elongated body to apply the dental composite material onto the tooth. The applicator further has a vibrating apparatus for vibrating the tip and a sensor for sensing a condition of the dental composite material. A controller is operatively coupled to the vibrating apparatus and to the sensor and is configured to automatically vary an output frequency of the vibrating apparatus in response to the condition sensed by the sensor. In a specific embodiment, the sensor is configured to sense a viscosity of the dental composite material. The sensor may, for example, be configured to sense a force exerted by the dental composite material on the tip.

A dental instrument is also provided that is substantially similar to the disclosed applicator, and is useful for purposes in addition to applying a dental composite material onto a tooth. To that end, the dental instrument can be used with a plurality of tips other than tips used for applying a dental composite material, and may be used for performing other dental procedures. For example, explorer tips may be used for inspecting a patient's teeth and retraction cord placement tips may be used for positioning a retraction cord around a patient's tooth. Advantageously, an applicator can be easily converted to such a dental instrument by merely changing the tip. Likewise, such a dental instrument can be easily converted to an applicator by changing the tip. In the form of an applicator with an appropriate tip, the dental instrument can be used to apply a dental composite material onto a tooth. Both the applicator and dental instrument disclosed herein offer advantages that will be described.

A kit of dental tools is also provided, including the applicator/dental instrument and a plurality of tips including one or more of: an applicator tip configured for applying a dental composite material to a tooth, an explorer tip configured for examining a patient's teeth, and a retraction cord placement tip configured for placing a retraction cord around a patient's tooth.

The controller for the applicator/dental instrument may be configured to decrease the output frequency in response to a sensed decrease in the force exerted by the dental composite material on the tip. Additionally or alternatively, the controller may be configured to increase the output frequency in response to a sensed increase in the force exerted by the dental composite material on the tip. In a specific embodiment, the elongated body defines a longitudinal axis of the applicator/dental instrument, with the sensor being configured to sense a force exerted by the dental composite on the tip that is orthogonal to the longitudinal axis. Additionally or alternatively, the sensor may be configured to sense a force exerted by the dental composite on the tip that is generally parallel to or along the longitudinal axis. Additionally or alternatively, the controller may have a plurality of predetermined algorithms of operation, with each of the algorithms defining a specific relationship between the sensed condition and the output frequency.

The vibrating apparatus may be operable to vibrate the tip with an output frequency in the range of about 80 Hz to about 500 Hz. The vibrating apparatus may, additionally or alternatively, be operable to vibrate the tip with an output amplitude in the range of about 0.1 mm to about 0.5 mm. In one specific embodiment, the tip is generally spherical, with the vibrating apparatus being operable to vibrate the generally spherical tip with a frequency in the range of about 100 Hz to about 500 Hz. The vibrating apparatus may be operable to vibrate the generally spherical tip with an amplitude of about 0.05 mm. The tip may be releasably coupled to the elongate body to thereby permit replacement thereof with another tip. In other embodiments, the tip includes a brush, a rotatable tip, an explorer tip, and a retraction cord placement tip.

The applicator/dental instrument, in some embodiments, is powered by a battery, with a compartment being defined in the elongated body thereof for receiving the battery.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a dental applicator in accordance with one embodiment of the present invention.

FIG. 2 is a perspective view illustrating an exemplary use of the applicator of FIG. 1.

FIG. 3 is a view similar to FIG. 2 illustrating an alternative embodiment of a tip of the applicator of FIGS. 1-2.

FIG. 3A is a perspective view of yet another alternative embodiment of a tip of the applicator of FIGS. 1-2.

FIG. 4 is a schematic elevation view of the applicator of FIGS. 1-2.

FIG. 5 is a graphical representation of an exemplary algorithm of operation of the applicator of FIGS. 1, 2, and 4 and the dental instrument of FIGS. 8-14.

FIG. 6 is a graphical representation of another exemplary algorithm of operation of the applicator of FIGS. 1, 2, and 4 and the dental instrument of FIGS. 8-14.

FIG. 7 is a graphical representation of yet another exemplary algorithm of operation of the applicator of FIGS. 1, 2, and 4 and the dental instrument of FIGS. 8-14.

FIG. 8 is a perspective view, similar to FIG. 1, of a dental instrument in accordance with another embodiment of the present invention.

FIG. 9 is an elevation view of a first explorer tip for the dental instrument shown in FIG. 8.

FIG. 10 is an elevation view of a second explorer tip for the dental instrument shown in FIG. 8.

FIG. 11 is a perspective view illustrating an exemplary use of the first explorer tip of FIG. 9.

FIG. 12 is a perspective view illustrating an exemplary use of the second explorer tip of FIG. 10.

FIG. 13 is a perspective view of a retraction cord placement tip for the dental instrument shown in FIG. 8.

FIG. 14 is a perspective view illustrating an exemplary use of the retraction cord placement tip of FIG. 13.

### DETAILED DESCRIPTION

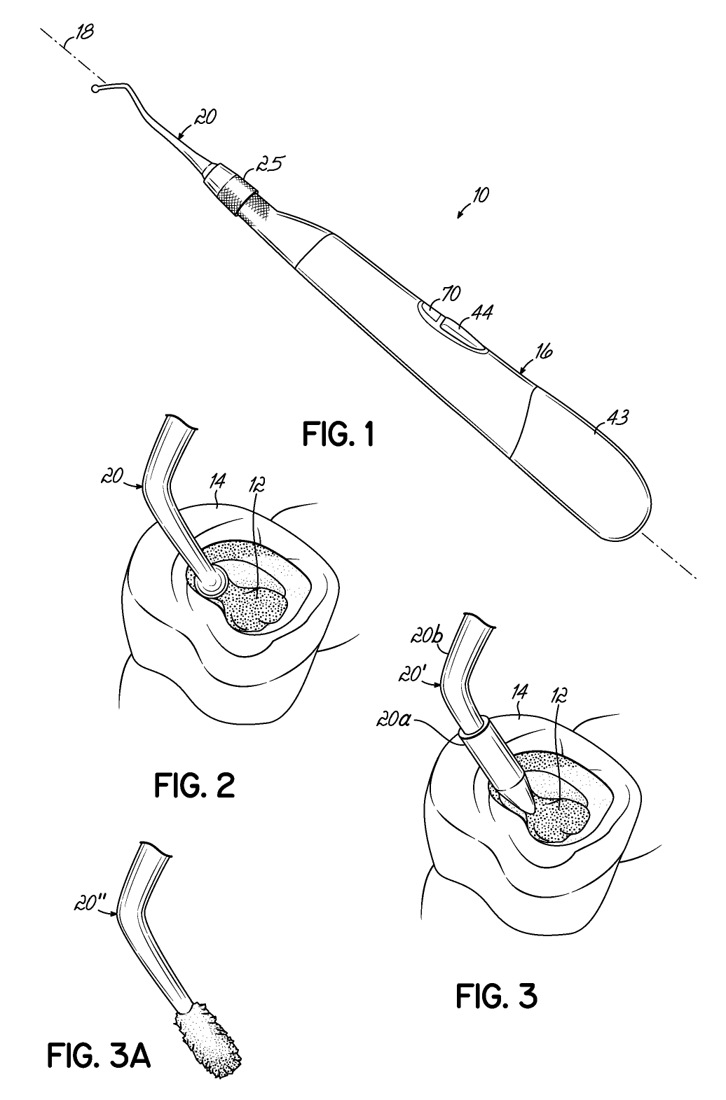

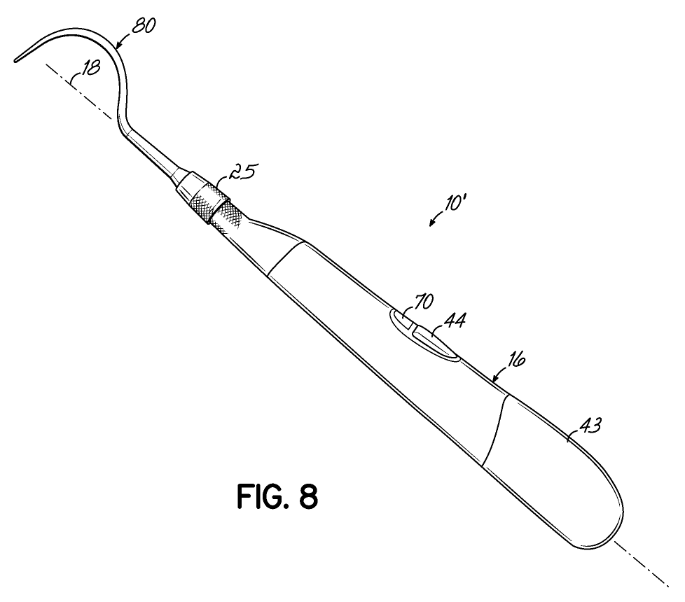

With respect to the figures, and particularly to FIGS. 1-3 and 3A, an exemplary dental instrument in the form of an applicator 10 is illustrated for applying a dental composite material 12 onto a tooth 14, where the term “applying” generally includes shaping, smoothing or any other manipulation of the dental composite material 12 on the tooth 14. The applicator 10 includes an elongated body 16 defining a handle of the applicator 10, and extending generally along a longitudinal axis 18. A tip 20 is coupled to a longitudinal end of the elongated body 16 and is configured to apply the composite material 12 to the tooth 14 during vibration of the tip 20. To this end, the tip 20 may take one of many different forms. For example, and without limitation, the tip 20 may have a working end having a generally spherical shape (FIGS. 1, 2, and 4), a generally conical shape, a generally cylindrical shape, or any other suitably chosen shape. In addition, further tips will be described below in association with a dental instrument 10′ and with reference to FIGS. 8-14. These further tips may be used for purposes other than applying a dental composite material onto a tooth.

As shown in FIG. 3A, a tip 20″ may include a working end in the form of a brush configured to provide a smoothing function on the composite material 12 being applied to the tooth 14. Or it may alternatively or additionally be in the form of a rotatable tip 20′ (FIG. 3), in which the tip 20′ has an end portion 20a that is rotatable relative to a main portion 20b of the tip 20′. The tip 20 is made of a suitably chosen material such as, for example, stainless steel or a plastic material, and may have a coating made of titanium nitride (TiN) or polytetrafluoroethylene (“PTFE”), or it may have no coating at all. Exemplary tips suitable for use with the applicator 10 of the present disclosure may also be found in U.S. patent application Ser. No. 10/736,262, assigned to the assignee of the present application, and the disclosure of which is hereby expressly incorporated herein by reference in its entirety.

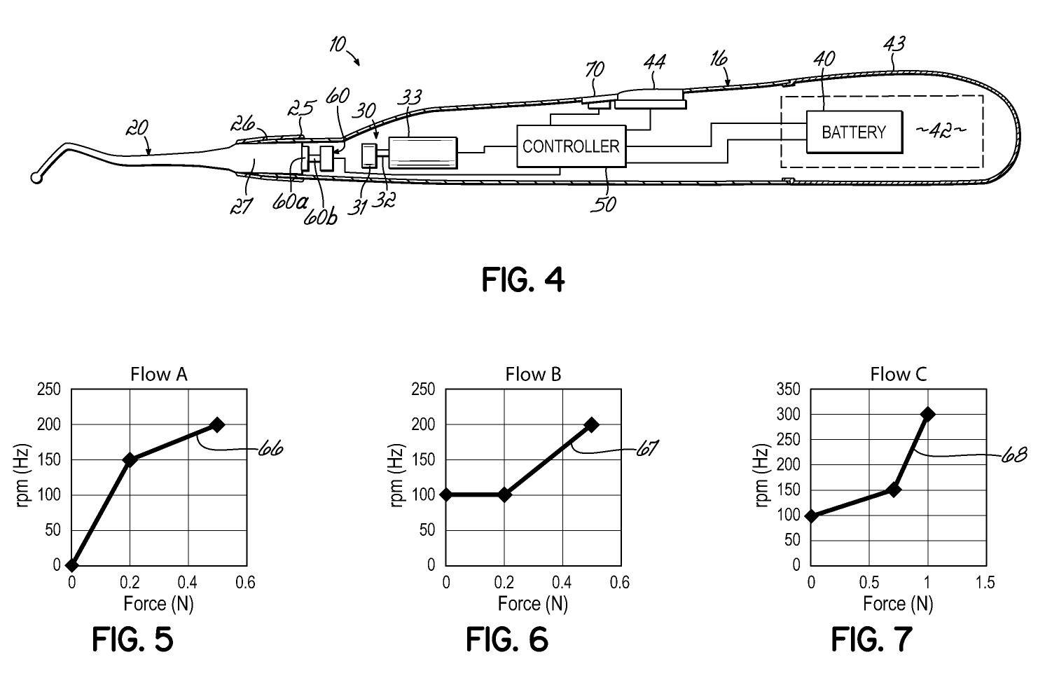

In one aspect of the illustrated embodiment, and with further reference to FIG. 4, coupling between the tip 20 and elongated body 16 is releasable, such that the tip 20 may be readily interchanged with other tips, according to the particular needs of the user. To this end, releasable coupling between the tip 20 and elongated body 16 includes a rotatable chuck 25 that secures a plurality of prongs 26, which in turn grip a base 27 of tip 20. Thus, any of tips 20, 20′, and 20″ may be easily coupled with the body 16 and used with the applicator 10 as part of applying a dental composite material to a tooth. This type of coupling is exemplary rather than intended to be limiting, insofar as other types of coupling may be chosen instead and still fall within the scope of the present disclosure.

The tip 20 of the embodiment of the figures is vibratable. To this end, the applicator 10 includes a vibrating apparatus 30 within the elongated body 16 that is operatively coupled to the tip 20 to impart thereon an output vibrating frequency and an output vibrating amplitude. For example, and without limitation, the vibrating apparatus 30 may take the form of an eccentric element 31 driven by a shaft 32 that is, in turn, connected to a motor 33. In this regard, rotation of the shaft 32 causes rotation of the eccentric element 31 which, in turn, causes vibration of the elongated body 16. In such exemplary embodiment, vibration is transferred from the elongate body 16 to the tip 20, to thereby result in vibration of the tip 20. Those of ordinary skill in the art will readily appreciate that the above-described type of vibrating apparatus 30 and the components thereof are merely illustrative rather than intended to be limiting, insofar as the vibrating apparatus 30 may take other suitably chosen forms and still fall within the scope of the present disclosure.

With particular reference to FIGS. 1 and 4, the vibrating apparatus 30 is powered by a power supply, in this embodiment, in the form of a battery 40 that is housed within a battery compartment 42 located within the elongated body 16, and which is accessible through a cover 43. The battery 40 provides power to motor 33, which is, in turn, operatively coupled to the tip 20 through the vibrating apparatus 30. A switch 44, also located in the elongated body 16, selectively opens and closes a circuit (not shown), to thereby selectively energize and de-energize the vibrating apparatus 30. In this regard, an alternative contemplated use of the applicator 10 includes manipulating the tip 20 to apply the composite material 12 while the tip 20 is not vibrating (i.e., with switch 44 in an “off” position). Notably, the exemplary battery 40 powering applicator 10 makes the applicator 10 less cumbersome than conventional devices that use an external power supply. It is contemplated, however, that an alternative embodiment of the applicator 10 may have a different type of power supply, which may or may not be located within the elongated body 16.

Operation of the vibrating apparatus 30 is controlled by a controller 50 (schematically depicted in FIG. 4) to which the vibrating apparatus 30 is operatively coupled. The controller 50 may, in a specific embodiment, be located within the elongated body 16, although this is merely exemplary rather than intended to be limiting. The controller 50 controls the output frequency and the output amplitude of vibration of the tip 20. In a specific embodiment, the output frequency of vibration of vibrating apparatus 30 is in the sonic range and may further be in the range of about 80 Hz to about 500 Hz, for example. Moreover, the output amplitude of vibration may be in the range of about 0.05 mm to about 0.5 mm, and more specifically in the range of about 0.1 mm to about 0.5 mm, for example. In this regard, different output frequencies of vibration may be chosen by the user of the applicator 10 in order to accommodate different types of composite materials 12 e.g., composite materials having different types of thixotropic behavior.

The output frequency of vibration of tip is 20 is automatically adjusted by the controller 50 in response to a sensed condition of the composite material 12. To this end, the applicator 10 includes a sensor 60 operatively coupled to the controller 50 and located, in this embodiment, proximate the tip 20. The sensor 60 of this embodiment is configured to sense the viscosity of the composite material 12 during application of the composite material 12 onto the tooth 14. More specifically, in this embodiment, the sensor 60 is located proximate the base 27 of tip 20, and has a pair of schematically depicted sensing elements 60a, 60b within the elongated body 16. The first sensing element 60a is configured to sense a force exerted by the composite material 12 onto the tip 20 that is orthogonal (e.g., generally perpendicular) to the longitudinal axis 18. The second sensing element 60b is configured to sense a force exerted by the composite material 12 onto the tip 20 that is generally parallel to or along the longitudinal axis 18. Upon vibrating engagement of the tip 20 with the composite material 12, one or both of the sensing elements 60a, 60b deflect by an amount associated with a predetermined force exerted by the composite material 12 onto the tip 20. In use, the sensor 60 generates a signal to the controller 50 that corresponds to the sensed force and the controller 50 automatically varies the output frequency of vibrating apparatus 30 and thus, of tip 20, in response to the signal. Those of ordinary skill in the art will readily appreciate that sensor 60 may alternatively take other forms and/or be at a location different from that illustrated in the figures.

In a specific embodiment, the sensed force may be indicative of an increase in viscosity of the composite material 12. In such case, the controller 50 may respond to the sensed force by increasing the output frequency of tip 20, which in turn is effective to decrease the viscosity to a desired, predetermined level. In another specific embodiment, the sensed force may be indicative of a decrease in viscosity of the composite material 12, in which case the controller 50 may respond to the sensed force by decreasing the output frequency of tip 20. This decrease in output frequency, in turn, is effective to increase the viscosity of the composite material 12 to the desired, predetermined level. A desired, predetermined level of viscosity of composite material 12 may correspond to a sensed force, exerted on the tip 20, of about 0.2 N, for example. Such desired, predetermined level of viscosity may correspond to a viscosity level at which the shear stress of the material permits conventional composite materials 12 to be easily distributed on the tooth and less likely to adhere to the surface of the tip 20.

With continued reference to FIGS. 1 and 4, and further referring to FIGS. 5-7, the applicator 10 may have several modes of operation, with each mode of operation being associated with one algorithm of operation of the controller 50, and each establishing a relationship between the sensed condition of the composite material 12 (e.g., the viscosity) and the output frequency. More specifically, the figures illustrate three different such algorithms 66, 67, 68 of operation, each relating the sensed force exerted by the composite material 12 on the tip 20 and the output frequency. In this regard, each of the algorithms 66, 67, 68 may correspond to a different type of composite material 12, such as a low-viscosity material, a high-viscosity material, a cement material for veneers or inserts, or a pit or fissure sealing material, for example.

In order to facilitate operation of applicator 10 in accordance with one of the algorithms 66, 67, 68, the applicator 10 is provided with a suitably located interface 70 (schematically depicted in the figures) permitting the user (e.g., dentist) to select among the several algorithms 66, 67, 68, for example, depending on the specific flow characteristics of the composite material 12 selected for the dental procedure. As illustrated in the exemplary algorithms 66, 67, 68, an output frequency in the range of about 100 Hz to about 150 Hz generally corresponds to a sensed force of 0.2 N, which in turn has been found, as discussed above, to correspond to a desirable level of viscosity and shear stress of the composite material 12. Operation of applicator 10 may thus involve automatically adjusting the output frequency based on the sensed force, so as to maintain a sensed force of about 0.2 N.

In use, one of the algorithms 66, 67, 68 may be chosen by the user. For example, the user may choose algorithm 68 (FIG. 7) for a specific type of composite material 12. As the applicator 10 engages the composite material 12 on the tooth 14, the force exerted by the composite material 12 onto the tip 20 is sensed by the sensor 60, which in turn generates a signal to the controller 50 indicative of the sensed force. If the sensed force is within an acceptable range (e.g., about 0.2 N) the controller 50 directs the vibrating apparatus 30 to continue to vibrate tip 20 with the same or similar output frequency and amplitude. If, on the other hand, the sensed force is indicative, for example, of an unacceptably high viscosity (e.g., the sensed force is higher than 0.2 N by more than a certain threshold), the controller 50, in response to the signal received from the sensor 60, directs the vibrating apparatus 30 to increase the output frequency until the viscosity of the material 12 decreases to a level corresponding to a sensed force of about 0.2 N.

For example, and with particular reference to FIG. 7, the sensed force may be about 0.7 N. In this regard, the controller 50 may direct the vibrating apparatus 30 to vibrate tip 20 with a frequency of about 110 Hz, for example, to thereby attain the target 0.2 N value of the sensed force, and which likely corresponds to a desired level of viscosity of the composite material 12. Conversely, if the sensed force is indicative, for example, of an unacceptably low viscosity (e.g., the sensed force is lower than 0.2 N by more than a certain threshold), the controller 50, in response to the signal received from the sensor 60, directs the vibrating apparatus 30 to decrease the output frequency of vibration of the tip 20 until the viscosity of the composite material 12 increases to a level corresponding to a sensed force of about 0.2 N.

In one aspect of this embodiment, the controller 50 may direct any adjustments in the output frequency to the vibrating apparatus 30 to be effected at an acceleration or deceleration rate that conforms with the expected behavior of the composite material 12, as predicted by the particular selected algorithm. Such controlled acceleration or deceleration may be desirable, for example, to prevent any overshoots or sudden drops in the viscosity of the composite material 12 as a result of an otherwise large increase or decrease of the output frequency over time.

While the tips 20, 20′, and 20″ are useful with the applicator 10 for applying a dental composite material onto a tooth in accordance with the concepts disclosed above, other tips may also be used for performing other dental procedures with the same dental instrument. In particular, the rotatable chuck 25 allows tips to be easily installed and removed, and the applicator 10 therefore advantageously can accept a host of tips in addition to the tips 20, 20′, and 20″ for purposes other than applying a dental composite material onto a tooth.

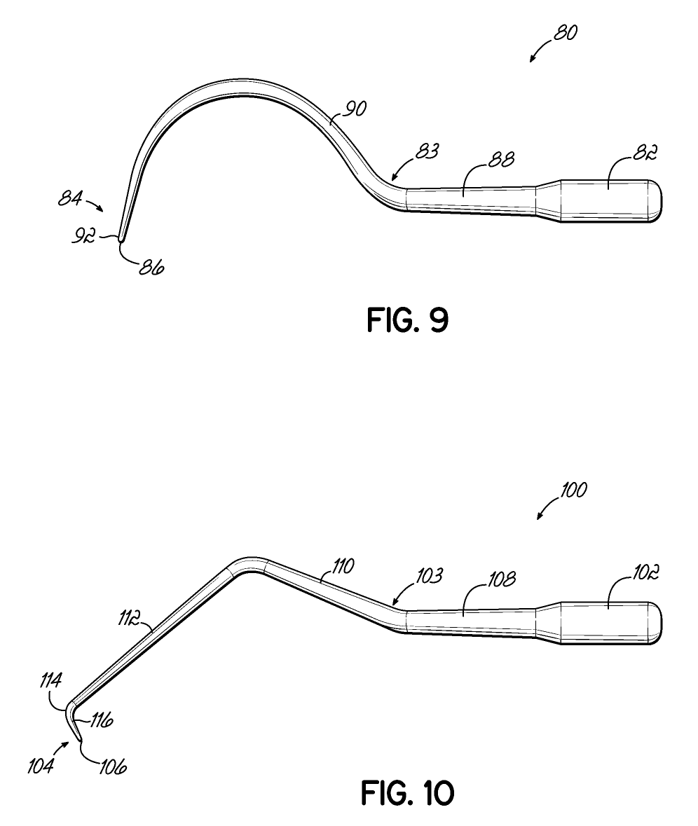

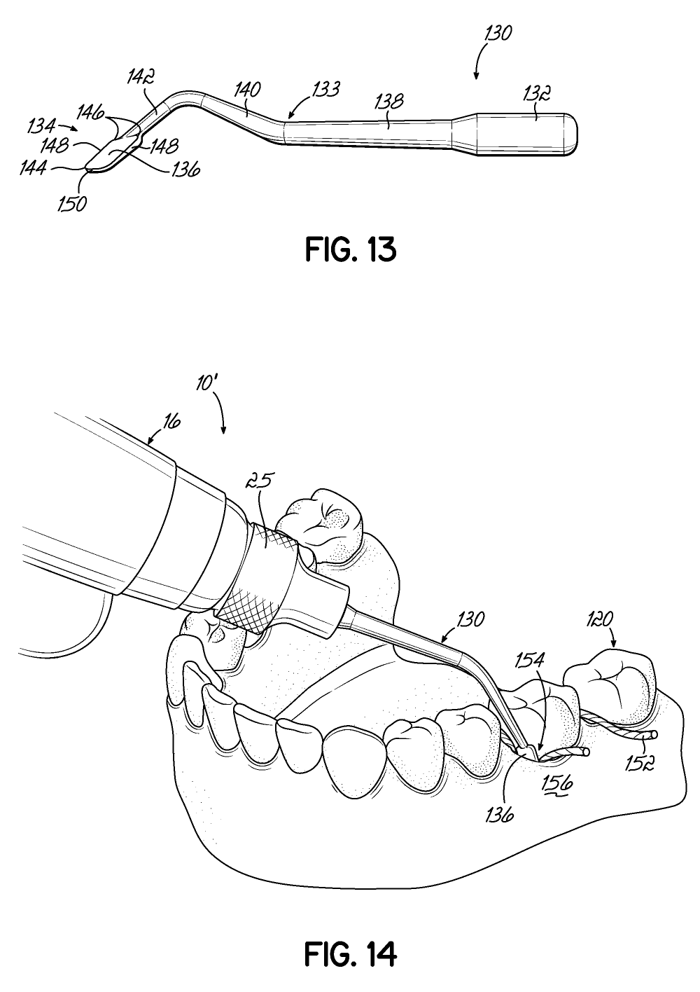

Referring next to FIGS. 8-14, several tips are described that can be used with a dental instrument 10′, that is in all respects similar to the applicator 10 other than its tip, as shown in FIG. 8. In particular, FIGS. 9-12 show explorer tips for use with dental instrument 10′ and FIGS. 13-14 show a retraction cord placement tip for use with dental instrument 10′. The dental instrument 10′ includes the same elongated body 16 extending along longitudinal axis 18, and includes the same rotatable chuck 25 for connecting a tip to the body 16. The dental instrument 10′ also includes the vibrating apparatus 30, power supply 40, controller 50, sensor 60, and user interface 70 and can be operated in the modes of operation described above with respect to algorithms 66, 67, and 68. The output frequency and output amplitude of the tips used in association with the dental instrument 10′ is the same as for the applicator 10.

With reference to FIG. 9, a first explorer tip 80 is shown. Explorer tip 80 extends from a base 82 along a main body portion 83 to a working end 84 terminating at a sharp point 86. The base 82 is configured to be connected with the elongated body 16 of the dental instrument 10′ by the rotatable chuck 25 in the same manner as discussed above for tips 20, 20′, and 20″. The main body portion 83 includes one or more curved or angular sections configured to permit a desired orientation of the working end 84 relative to the tooth surface to be explored. In the embodiment shown, a first section 88 extends from the base 82 in a generally linear direction, so that when the explorer tip 80 is installed in the elongated body 16 the first section 88 is generally parallel to the longitudinal axis 18. A second section 90 extends from the first section 88 away from the base 82 in an arcuate or hook shape, with the working end 84 positioned at a distal end 92 of the second section 90 away from the first section 88. Other configurations for the main body portion 83 are also contemplated. The main body portion 83 of the explorer tip 80 has a generally circular transverse cross section, the size of which tapers between the base 82 and the working end 84 to the sharp point 86. The explorer tip 80 is made of a suitably chosen material, for example, stainless steel or a plastic material, and may have a coating made of titanium nitride (TiN) or polytetrafluoroethylene (“PTFE”), or it may have no coating at all.

In FIG. 10, a second explorer tip 100 is shown. Explorer tip 100 extends from a base 102 along a main body portion 103 to a working end 104 terminating at a sharp point 106. The base 102 is configured to be connected with the elongated body 16 of the dental instrument 10′ by the rotatable chuck 25 in the same manner as the tips 20, 20′, 20″, and 80. In this embodiment, a first section 108 of the main body portion 103 extends from the base 102 in a generally linear direction, so that when the explorer tip 100 is installed in the elongated body 16 the first section 108 is generally parallel to the longitudinal axis 18. A second section 110 extends from the first section 108 in a generally linear direction and at an obtuse angle from the first section 108. A third section 112 extends from the second section 110 in a generally linear direction and at an obtuse angle from the second section 110 toward a distal end 114. A fourth section 116 extends from the third section 112 at the distal end 114 toward the working end 104. The fourth section 116 extends, at least in part, toward the base 102 so that the sharp point 106 is inside the distal end 114, or between the distal end 114 and the base 102. Other configurations for the main body portion 103 are also contemplated. The main body portion 103 of the explorer tip 100 also has a generally circular transverse cross section, the size of which tapers between the base 102 and the working end 104 to the sharp point 106. The explorer tip 100 is made of a suitably chosen material, for example, stainless steel or a plastic material, and may have a coating made of titanium nitride (TiN) or polytetrafluoroethylene (“PTFE”), or it may have no coating at all.

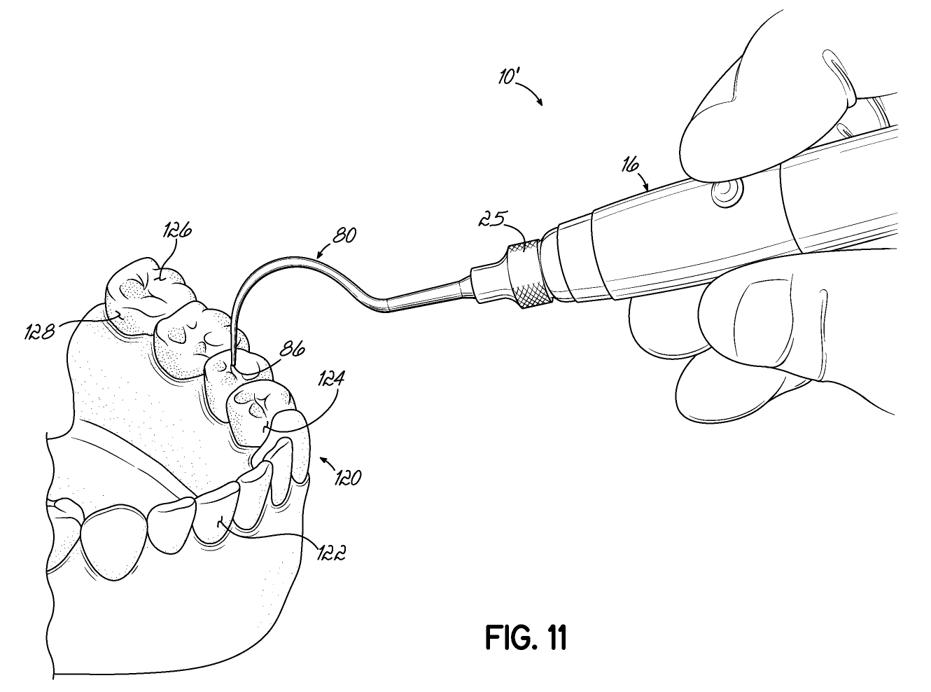

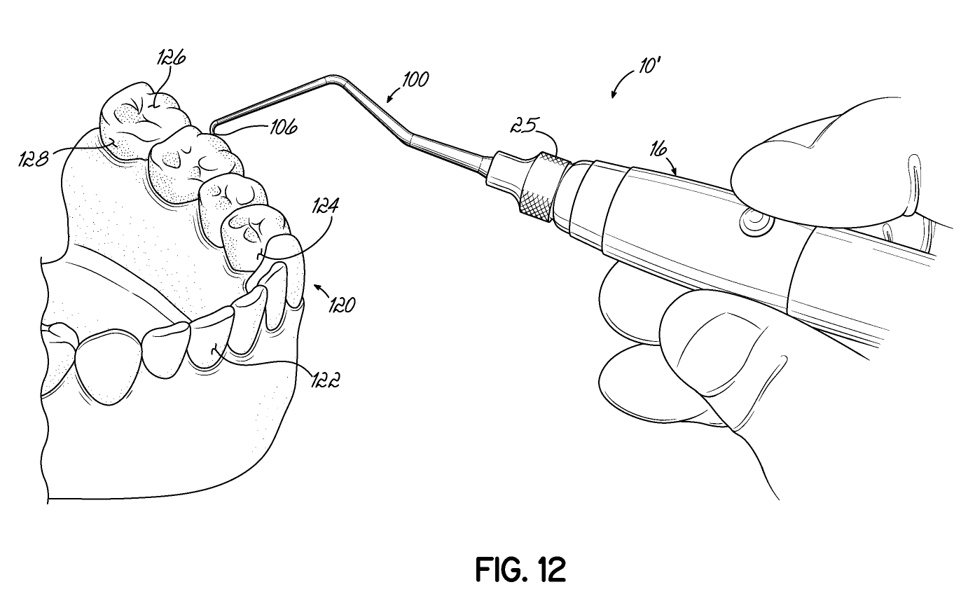

Both the first explorer tip 80 and the second explorer tip 100 may be attached to the elongated body 16 as part of the dental instrument 10′, such as what is shown in FIG. 8 with the first explorer tip 80. With reference to FIGS. 11 and 12, the dental instruments 10′, including explorer tips 80 and 100, respectively, may be used by a dental professional as part of an inspection of a patient's teeth 120, such as to probe for the presence of tooth decay or cavities, as is well known in the art. In particular, the sharp points 86, 106 are used to probe for tooth decay on tooth surfaces, including the buccal surfaces 122 (surfaces adjacent the inside of the cheek), the proximal surfaces 124 (surfaces of teeth adjacent another tooth), the occlusal surfaces 126 (the biting surfaces), and the lingual surfaces 128 (surfaces adjacent the tongue). Advantageously, a dental instrument 10′ having either of the explorer tips 80, 100 may be used with the vibrating apparatus 30 energized so the tip 80, 100 vibrates. The vibration of the tip 80, 100 reduces the friction between the tip 80, 100 and the teeth 120 and enhances a patient's sensitivity to an inspection with the dental instrument 10′ as compared with conventional explorer tips. Increased sensitivity is beneficial for a dental professional searching for tooth decay, as a patient's sensitivity to an exploration is indicative of possible tooth decay. While the sensor 60 is useful for measuring forces indicative of the viscosity of a dental composite material, as discussed above, the operation of the dental instrument 10′ with either of the explorer tips 80, 100 may not take into consideration the measurements gathered by the sensor 60. Accordingly, vibration of the tips 80, 100 advantageously occurs at the frequencies and amplitudes useful for the purposes of the applicator 10 for applying a dental composite material for a tooth. In other words, the frequency and amplitude of vibration need not be adjusted for using the dental instrument 10′ with the tips 80, 100.

With reference to FIGS. 13 and 14, a retraction cord placement tip 130 is shown. The retraction cord placement tip 130 extends from a base 132 along a main body portion 133 to a working end 134 having a flat paddle section 136. The base 132 is configured to be connected with the elongated body 16 of the dental instrument 10′ by the rotatable chuck 25 in the same manner as the tips 20, 20′, 20″, 80, and 100. In this embodiment, a first section 138 of the main body portion 133 extends from the base 132 in a generally linear direction, so that when the retraction cord placement tip 130 is installed in the elongated body 16 the first section 138 is generally parallel to the longitudinal axis 18. A second section 140 extends from the first section 138 in a generally linear direction and at an obtuse angle from the first section 138. A third section 142 extends from the second section 140 in a generally linear direction and at an obtuse angle from the second section 140 toward the flat paddle section 136. Other configurations for the main body portion 133 are also contemplated. The flat paddle section 136 extends from the third section 142 to a distal end 144 of the tip 130. The flat paddle section 136 includes shoulders 146 extending from the third section 142, sides 148 extending from the shoulders 146 toward the distal end 144, and a generally flat edge 150 at the distal end 144. The sides 148 connect with the flat edge 150 at the distal end 144. The main body portion 133 (e.g. first, second and third sections 138, 140, 142) have a generally circular transverse cross section, and the flat paddle section 136 has a generally trapezoidal surface shape and its thickness may taper or diminish from the region of the shoulders 146 toward the flat edge 150 at the distal end 144, as shown. The retraction cord placement tip 130 is made of a suitably chosen material, for example, stainless steel or a plastic material, and may have a coating made of titanium nitride (TiN) or polytetrafluoroethylene (“PTFE”), or it may have no coating at all.

The retraction cord placement tip 130 may be attached to the elongated body 16 as part of the dental instrument 10′, as shown in FIG. 14. A dental instrument 10′ having the retraction cord placement tip 130 may be used by a dental professional for placing a retraction cord 152 around any of a patient's teeth 120. Particularly, the working end 134 having the flat paddle section 136 is used to insert the retraction cord 152 into a pocket 154 formed between a tooth and the gingiva 156. Advantageously, a dental instrument 10′ having the retraction cord placement tip 130 may be used with the vibrating apparatus 30 energized so the tip 130 vibrates. The vibration of the tip 130 reduces the frictional engagement between the retraction cord 152, the gingiva 156, and the teeth 120, thereby making insertion of the cord 152 into the gingiva 156 easier. While the sensor 60 is useful for measuring forces indicative of the viscosity of a dental composite material, as discussed above, the operation of the dental instrument 10′ with the retraction cord placement tip 130 may not take into consideration the measurements gathered by the sensor 60. Accordingly, vibration of the tips 130 advantageously occurs at the frequencies and amplitudes useful for the purposes of the applicator 10 for applying a dental composite material for a tooth. In other words, the frequency and amplitude of vibration need not be adjusted for using the dental instrument 10′ with the tip 130.

It will be appreciated that since the applicator 10 and the dental instrument 10′ differ only with respect to the tip that is installed therein, an applicator 10 having any of the tips 20, 20′, or 20″ may be easily converted to a dental instrument 10′ having any of the tips 80, 100, or 130. Likewise, a dental instrument 10′ having any of the tips 80, 100, or 130 may be easily converted to an applicator 10 having any of the tips 20, 20′, or 20″. Thus, the same general dental instrument may be used for several different dental procedures, depending on the tip used.

Additionally, the vibrating tip provides advantages to the several purposes for which the applicator 10 and the dental instrument 10′ may be used. Particularly, in the applicator 10, the vibrating tip (whether 20, 20′, or 20″) is used in conjunction with the controller 50 and the sensor 60 to adjust the viscosity of the composite material being applied to a tooth. In the dental instrument 10′, the vibrating tip (whether 80, 100, or 130) reduces friction between the tip and a patient's teeth, or between the tip, the patient's teeth and gingiva, and a retraction cord. In addition, the vibrating explorer tip (80 or 100) may increase a patient's sensitivity to an inspection, which is beneficial for a dental professional searching for tooth decay.

Accordingly, a kit of dental tools may be provided that includes a dental instrument and a plurality of tips. For example, either an applicator 10 or a dental instrument 10′ can be provided as part of the kit, as well as applicator tips configured for applying a dental composite material to a tooth (20, 20′, and/or 20″), explorer tips configured for examining a patients teeth (tips 80 and/or 100), a retraction cord placement tip configured for placing a retraction cord around a patient's tooth (130), or any combination of such tips. Further, additional tip configurations may be included in the kit, such as tips having differently angled and/or curved main body portions and differently shaped working ends, as may be desired for different procedures to provide different access angles to the tooth surfaces.

While the invention has been illustrated by the description of one or more embodiments thereof, and while the embodiments have been described in considerable detail, they are not intended to restrict or in any way limit the scope of the invention to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. A vibrating dental instrument, comprising:
an elongated body;
a tip releasably coupled to said elongated body;
a vibrating apparatus for vibrating said tip;
a sensor configured to sense a condition of a dental composite material when the tip is used to apply dental composite material onto a tooth; and
a controller operatively coupled to said vibrating apparatus and to said sensor and configured to automatically vary an output frequency of said vibrating apparatus in response to the condition sensed by said sensor.

2. The dental instrument of claim 1, wherein said sensor is configured to sense a viscosity of the dental composite material.

3. The dental instrument of claim 2, wherein said sensor is configured to sense a force exerted by the dental composite material on said tip.

4. The dental instrument of claim 3, wherein the tip includes a main body portion having one or more curved or angled sections and an explorer tip having a sharp point for probing for tooth decay on a patient's teeth.

5. The dental instrument of claim 4, wherein the explorer tip includes a base, a first section extending from the base in a generally linear direction, and a second section extending from the first section in an arcuate shape, the sharp point being positioned at an end of the second section away from the first section.

6. The dental instrument of claim 4, wherein the explorer tip includes a base, a first section extending from the base in a generally linear direction, a second section extending from the first section in a generally linear direction and at an obtuse angle from the first section, a third section extending from the second section in a generally linear direction and at an obtuse angle from the second section, and a fourth section extending from the third section, the sharp point being positioned at an end of the fourth section away from the third section.

7. The dental instrument of claim 3, wherein the tip includes a retraction cord placement tip for placing a retraction cord around a patient's tooth.

8. The dental instrument of claim 7, wherein the retraction cord placement tip includes a working end having a flat paddle section.

9. The dental instrument of claim 8, where the retraction cord placement tip includes a main body portion and the flat paddle section extends from the main body portion, the flat paddle section including shoulders extending from the main body portion, sides extending from the shoulders, and a flat edge at a distal end of the retraction cord placement tip.

10. The dental instrument of claim 3, wherein the tip includes an applicator tip configured to apply a dental composite material to a tooth, the applicator tip including one of a generally spherical portion, a brush, and a rotatable portion.

11. A kit of dental tools, comprising:
a dental instrument having an elongated body, structure for releasably coupling a tip to said elongated body, a vibrating apparatus for vibrating said tip, a sensor configured to sense a condition of a dental composite material when a tip is used to apply dental composite material onto a tooth, and a controller operatively coupled to said vibrating apparatus and to said sensor and configured to automatically vary an output frequency of said vibrating apparatus in response to the condition sensed by said sensor; and
a plurality of tips for coupling with said dental instrument, the plurality of tips including one or more of: an applicator tip configured for applying a dental composite material to a tooth, an explorer tip configured for examining a patient's teeth, and a retraction cord placement tip configured for placing a retraction cord around a patient's tooth.

12. A kit according to claim 11, wherein the plurality of tips includes an applicator tip configured for applying a dental composite material to a tooth, an explorer tip configured for examining a patient's teeth, and a retraction cord placement tip configured for placing a retraction cord around a patient's tooth.
